(19) United States
(12) Patent Application Publication
(10) Pub. No.: US 2009/0303003 A1
(43) Pub. Date: Dec. 10, 2009

(54) RFID SMART BOX

(75) Inventors: Daryl L. Pritchard, Shenandoah, TX (US); Eric Sullivan, Houston, TX (US); Tu T. Trinh, Houston, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: BAKER HUGHES INCORPORATED, Houston, TX (US)

(21) Appl. No.: 12/134,042

(22) Filed: Jun. 5, 2008

(51) Int. Cl. H04Q 5/22

(52) U.S. Cl. 340/10.1

(57) ABSTRACT

A module for identifying contents of a container, the module comprising an interrogation trigger, an interrogation transmitter, a response receiver, and a response transmitter. The module may be embedded within a wall of the container or affixed to an outside surface of the container. The module may be an active device initiating an interrogation or a passive device merely responding to a received interrogation signal.

### CROSS REFERENCE TO RELATED APPLICATIONS

None.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to shipping containers; and more specifically related to identifying contents of a container.

2. Description of the Related Art

U.S. Pat. No. 7,075,437 teaches “[a]n RFID relay device for an RFID transponder and methods are provided for relaying an RFID signal. The RFID relay device comprises at least two antenna and a transmission line coupling the at least two antenna. In addition to the two antenna and the transmission line, the RFID relay device comprises an impedance adjusting circuit coupled to the transmission line and configured for coupling to the RFID transponder.”

U.S. Pat. No. 7,113,125 teaches “[a] level of liquid of pulverent solids in a container (or volume of a liquid in the absence of gravity) is detected by using radio frequency identification (RFID) tags or similar transponders located inside or outside the container. The interrogation signal and/or the return signal is attenuated by the material and the signal strength of the return signal, if any, is evaluated either directed or in a binary fashion by imposing a threshold to determine whether or not material in contained in a portion of the container corresponding to the location of a particular RFID tag or transponder. Volume, pressure and container orientation can also be derived in accordance with one or more return signals.”

U.S. Pat. No. 7,142,124 teaches “[a] method and system is disclosed for enabling quantities of bulk-type products to be determined using RFID tags that can also be used to determine the existence of product or packaging containing RFID tags. Packaging and/or containers for the bulk products are configured so that the RFID tags contained thereon provide an indication of an approximate relative quantity of the bulk material. More specifically, the position and/or shielded or unshielded state of RFID tags are utilized to identify a quantity of the bulk-type material.”

U.S. Patent Application No. 20050264422 teaches “[a]n IC tag communication relay device is provided with an antenna section, lead lines and input/output unit. The antenna section is equipped with one or more antennas for transmitting and receiving electromagnetic radiation to and from IC tags. The lead lines are connected to each antenna for transmitting electrical signals corresponding to transmitted and received electromagnetic radiation. The input/output unit is arranged outside of the antenna corresponding to each antenna connected to the lead lines.”

U.S. Patent Application No. 20070001809 teaches “[a]n automatic data collection system reads data encoded in data carriers located inside enclosed environments, such as radio frequency identification (RFID) tags attached to objects located in enclosures, such as buildings, shipping containers, transportation vehicles such as airplanes, and other enclosures. The enclosures have dimensions that normally exceed the read range of the RFID tags, and/or the enclosures are composed of a material (such as metal) that impede communication of signals with external RFID readers. Therefore, internal antenna systems are provided inside of the enclosures to relay interrogation signals from RFID readers to the RFID tags, and to relay response signals from the RFID tags back to the RFID readers.”

U.S. Patent Application No. 20070171073 teaches “a repeater relays an RF signal between an RFID (radio frequency identification) transponder having a transponder antenna, and an RFID reader having a reader antenna. The repeater includes a first antenna configured to be coupled with the reader antenna; a second antenna configured to be coupled with the transponder antenna; and a first coaxial cable which is coupled to the first and second antennas.”

The inventions disclosed and taught herein are directed to an improved system for identifying the contents of a container.

### BRIEF SUMMARY OF THE INVENTION

A system for identifying contents of a container, including a module comprising an interrogation trigger, an interrogation transmitter, a response receiver, and a response transmitter. The module may be embedded within a wall of the container or affixed to an outside surface of the container. The module may be an active device initiating an interrogation or a passive device merely responding to a received interrogation signal.

### BRIEF DESCRIPTION OF THE SEVERAL VIEWS OF THE DRAWINGS

FIG. 1 illustrates a perspective view of one embodiment of a system for identifying contents of a container of the present invention;

FIG. 2 illustrates a sectional elevation view of one embodiment of the system of the present invention;

FIG. 3 illustrates a sectional elevation view of another embodiment of the system of the present invention;

FIG. 4 illustrates a block diagram of one embodiment of a module of the system of the present invention;

FIG. 5 illustrates a flow chart of certain functionality of the system of the present invention;

FIG. 6 illustrates a perspective view of a second embodiment of the system of the present invention; and

FIG. 7 illustrates another perspective view of the second embodiment of the system of the present invention.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Applicants have created a system for identifying contents of a container, the system comprising a module having an interrogation trigger, an interrogation transmitter; a response receiver; and a response transmitter. The module may be embedded within a wall of the container or affixed to an outside surface of the container. The module may be active initiating an interrogation or passive merely responding to a received interrogation signal.

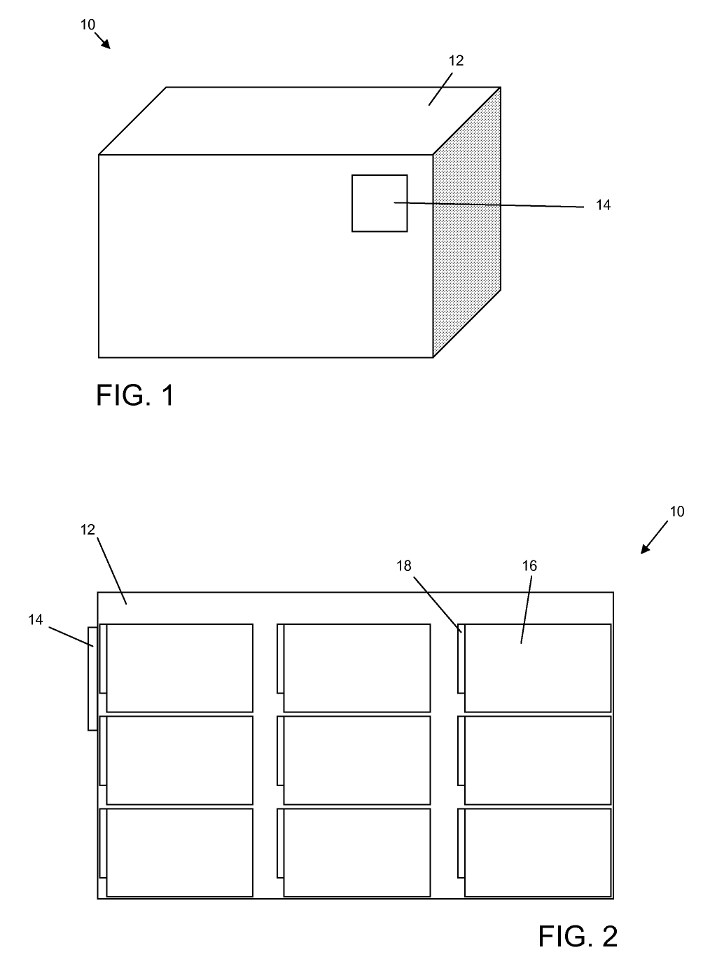

FIG. 1 is an illustration of one embodiment of the present invention showing a system 10 for identifying contents of a container 12. The container 12 is typically a shipping or transportation container, such as a box or a crate. The system 10 preferably includes a module 14 affixed to the container 12. As will be discussed in greater detail below, the module 14 provides information as to the contents of the container 12.

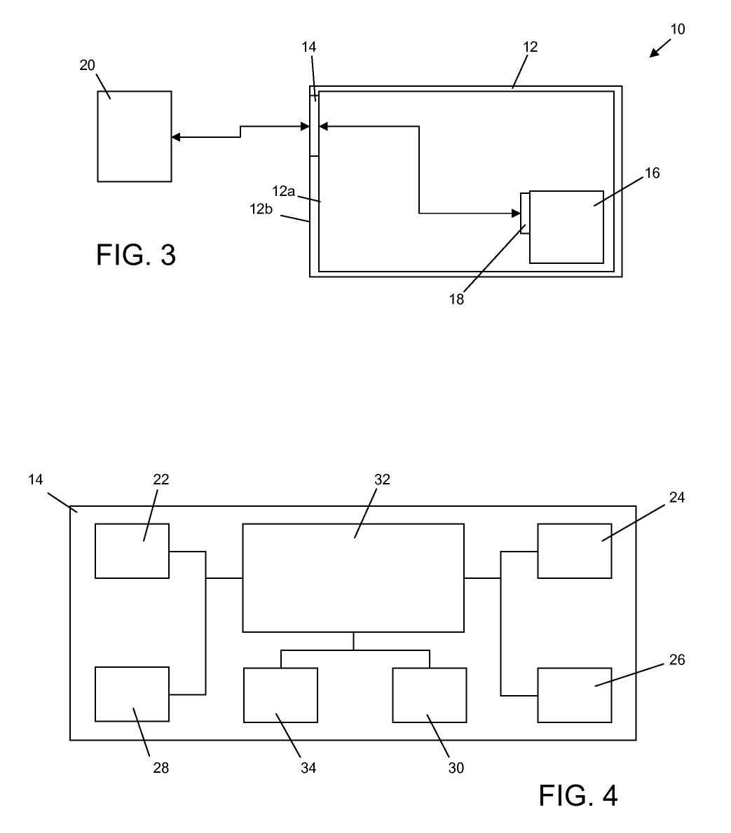

Referring also to FIGS. 2 and 3, the module 14 may be affixed to an outside surface of the container 12 or may be integrated or embedded within a wall of the container 12. The module 14 may be affixed using, for example, double sided tape before, during, or after the container 12 is packed. Alternatively, the module 14 may be embedded within a sidewall of the container 12 during manufacturing of the container 12. More specifically, each wall of the container 12 may include an inner panel 12a and an outer panel 12b, with the module 14 embedded between the panels 12a,12b. In either case, the module 14 may be reusable each time the container 12 is reused.

In one embodiment, the container 12 is designed to hold one or more earth boring drill bits 16 of the type commonly used in oil and gas operations. These drill bits 16 commonly have radio frequency identification devices (RFID) 18 affixed to them for identification, tracking, and inventory control purposes. These RFID tags 18 are preferably coded to identify the drill bit 16 to which they are attached. The RFID tags 18 respond to an interrogation signal with a response signal containing information, such as an identification code, that either directly identifies the drill bit 16 or can be cross-referenced to a database to indirectly identify the drill bit 16.

Typical containers 12 used in this application often degrade or otherwise attenuate signals to and from the RFID tags 18, greatly reducing the range at which the RFID tags 18 are effective. When several containers 12 are stacked in a storeroom or on a pallet, signals to and from the RFID tags 18 within the containers 12 in the back or bottom of a stack may be too attenuated to be effectively transferred without breaking down the stack.

The module 14 of the present invention preferably interrogates the RFID tags 18 of the drill bits 16 within the container 12 and makes information received from the bits 16 available to an external RFID reader 20, or similar device. More specifically, as will be discussed in greater detail below, the module 14 of the present invention sends an interrogation signal into the container 12 and receives one or more response signals from one or more RFID tags 18 within the container 12. The module 14 may then send the information from the response signal(s) to the external reader 20.

In one embodiment, referring also to FIG. 4, the module 14 includes an interrogation trigger 22, an interrogation transmitter 24, a response receiver 26, and a response transmitter 28. Upon activation of the interrogation trigger 22, the interrogation transmitter 24 sends an interrogation signal into the container 12, the response receiver 26 receives a response signal from the RFID tags 18 within the container 12, and thereafter the response transmitter 28 is operable to forward information from the response signal to the external reader 20.

The interrogation trigger 22 may be an interrogation receiver that receives an interrogation signal from the external reader 20. This embodiment envisions the module's 14 interaction with the reader 20 occurring substantially concurrently with the module's 14 interaction with the RIFD tags 18 within the container. However, that is not necessarily the case. For example, the module 14 may interrogate the contents of the container 12 the first time it receives the interrogation signal and may thereafter make the information from the response signal(s) available for future exchanges with the reader 20, without needing to interrogate the contents of the container 12 again. Thus, the module 14 may include a reconfigurable memory 30 to store the information from the response signal(s). The module 14 may also include a reset switch or button (not shown), after activation of which the module 14 will thereafter interrogate the contents of the container 12 again, upon receipt of an interrogation signal from the reader 20.

In any case, where the interrogation trigger 22 is essentially an interrogation receiver, the module 14 may be powered by the interrogation signal from the external reader 20. The module 14 may or may not actually store the information received from the RIFD tag(s) 18. If the module 14 does store the information internally, the memory 30 may be written to, or otherwise reconfigured, using the power from the interrogation signal from the external reader 20.

Alternatively, the interrogation trigger 22 may be a button or switch activated by a user. For example, a user may place items, such as the drill bits 16, having their own RFID tags 18 into the container 12 and then activate the trigger 22 by pressing the button or actuating the switch, thereby initiating the process described above. This embodiment envisions interaction with the reader 20 occurring at some point in the future. Thus, in this embodiment, the module 14 preferably includes the reconfigurable memory 30 operable to store the information received by the response receiver 26 for future transmission by the response transmitter 28.

The module 14 may also include interconnecting and/or supervisory control circuitry 32 to facilitate the functionality of the present invention. The control circuitry 32 may be relatively simple logic and interconnections. Alternatively, or additionally, the control circuitry 32 may include one or more processors to control the functionality of the present invention. The module 14 may also include a power source 34, such as a battery or photovoltaic panel, to power the various circuitry of the present invention.

In the preferred embodiment, the interrogation trigger 22, the interrogation transmitter 24, the response receiver 26, the response transmitter 28, the memory 30, the circuitry 32 and the power source 34 are all preferably embedded within the module 14. Thus, the module 14 preferably embodies a self-contained RFID repeater. As discussed above, the module 14 may be essentially passive, wherein the module 14 interrogates the contents of the container 12 when interrogated by the reader 12, and possibly even using power from the interrogation signal from the external reader 20. Alternatively, the module 14 may be active and interrogate the contents of the container 12 on command. Any such command could be an interrogation signal from the reader 20 or may be an action by an operator or other user, such as depressing a button or other action. Either version of the module 14 may incorporate the memory 30 and/or internal power source 34. Thus, the module 14 may represent a combined RFID reader and tag, appearing to be a reader to the RFID tags 18 within the container 12 and appearing to be a RFID tag to the external reader 20.

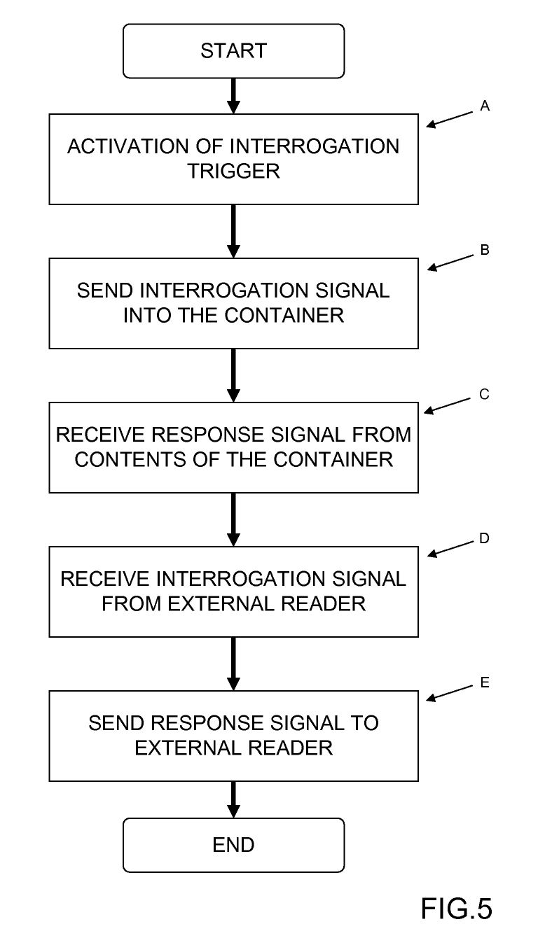

In use, as shown in FIG. 5, items, such as the drill bits 16 are placed within the container 12. As discussed above, the items preferably have their own RFID tags 18 affixed to them. The module 14 is preferably affixed to the outside of the container 12. Alternatively, the module 14 may be embedded within a wall of the container 12. In either case, once the items are placed within, and the module 14 is affixed to, the container 12, the interrogation trigger 22 is activated, as shown in step A.

The module 14 then sends an interrogation signal into the container 12 interrogating one or more RFID tags 18 within, as shown in step B. The RFID tags 18 respond with a response signal containing information identifying the item to which each tag is attached. The module 14 receives one or more response signals, as shown in step C.

The module 14 may consolidate and/or store the information from the response signal(s) in the memory 30. Alternatively, or additionally, the module 14 may immediately forward that information to the external reader 20 or some other device. Assuming the information was stored in the memory, the module 14 then waits for an interrogation signal from the reader 20. When the module 14 receives the interrogation signal from the reader 20, as shown in step D, the module 14 responds by sending its own response signal to the reader 20, as shown in step E.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. For example, as discussed above, the interrogation trigger 22 may be activated by reception of the interrogation signal from the reader 20, thereby combining steps A and D.

The module's 14 response signal may be substantially identical to the response signal the module 14 received from the contents of the container 12. This embodiment is especially advantageous where the container 12 is designed to contain only one item and the module 14 is designed to act as a simple relay for a single RFID tag 18 within the container 12. In this case, the module's 14 response signal may or may not identify the container 12 itself.

Alternatively, the module's 14 response signal may be substantially different than the response signals the module 14 received from the contents of the container 12. This embodiment is especially advantageous where the container 12 is designed to contain multiple items and the module 14 is designed to consolidate the information from multiple RFID tags 18 within the container 12. The module's 14 response signal may identify the container 12 and provide an inventory of the container's 12 contents, individually listing the contents and/or totaling, summing, or aggregating the contents. Alternatively, the module's 14 response signal may not identify the container 12 and merely provide an inventory of the container's 12 contents.

A hybrid approach is also possible. For example, the module 14 may interrogate the contents of the container 12 and receive multiple response signals. Rather than combining the information from those multiple response signals into a single response signal of its own, the module 14 may respond to the reader 20 with multiple response signals, with each being substantially identical to one of the multiple response signals received from within the container 12. These multiple response signals may or may not identify the container 12 itself.

Other and further embodiments utilizing one or more aspects of the inventions described above can be devised without departing from the spirit of Applicant's invention. For example, the various methods and embodiments of the module 14 can be included in combination with each other to produce variations of the disclosed methods and embodiments. More specifically, the interrogation trigger 22 and the power source 34 may be combined into a photovoltaic panel, such that whenever the panel is exposed to sufficient light, the module 14 interrogates the contents of the container 12 and stores the response information in the memory 30 and/or transmits that information using the response transmitter 28.

The above described transmitters and receivers may be combined into transceivers and each preferably include the requisite antenna and circuitry normally associated therewith. As implicated in the above discussion and figures, the antenna(s) for the interrogation trigger 22 and the response transmitter 28 are preferably oriented toward an exterior, or away from an interior, of the container 12. Conversely, the antenna(s) for the interrogation transmitter 24 and the response receiver 26 are preferably oriented toward an interior of the container 12.

In an alternative embodiment, the module 14 may be located entirely within the container 12. One advantage of this embodiment is that the container 12 may protect the module 14 from impacts or other damage. One disadvantage of this embodiment is that the module 14 may suffer from signal interference and degradation caused by the container 12.

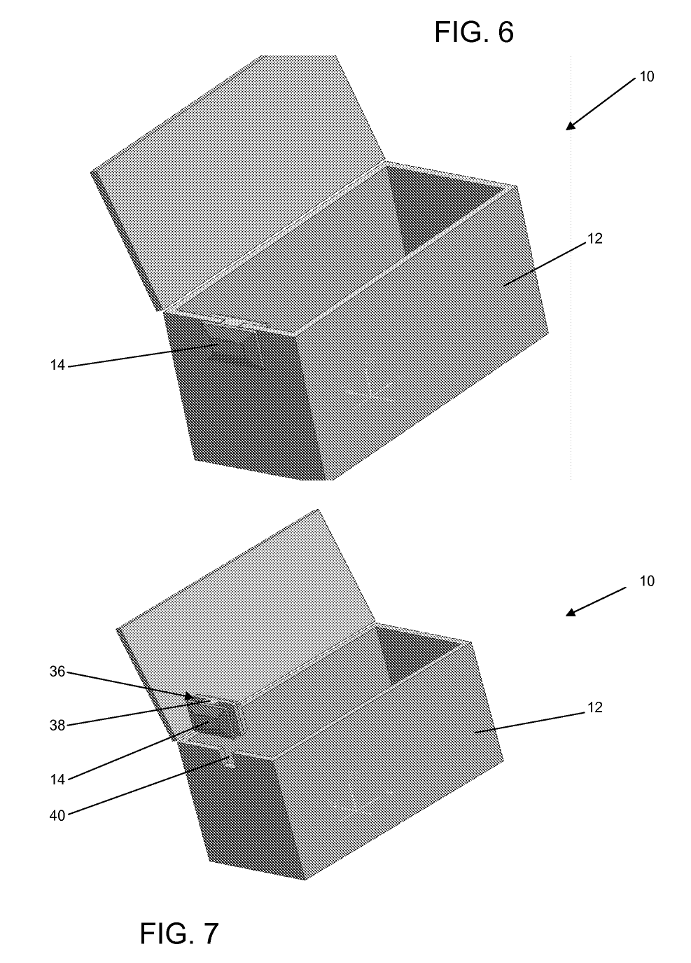

Therefore, in still another embodiment of the present invention, referring also to FIGS. 6 and 7, the module 14 may extend through a sidewall of the container 12. In this embodiment, the antenna(s) for the interrogation trigger 22 and the response transmitter 28 may reside outside the container 12, while the antenna(s) the for interrogation transmitter 24 and the response receiver 26 reside inside the container 12. In this embodiment, the module 14 may include a number of channels 36 surrounding a central body section 38 that fits within a notch or slot 40 in the sidewall of the container 12. The module 14 may be held in place by frictional engagement with the container 12, by a fastener, such as a screw, by an adhesive, or simply by configuration of the container 12, such as by closing a lid of the container 12.

One advantage of this embodiment is that much of the module 14 may be protected by the container 12, without suffering from signal interference and degradation caused by the container 12. Another advantage of this embodiment is that the module 14 may be mounted on existing containers 12 and/or be swapped out and used on different boxes. However, this last advantage may also be a disadvantage, in that one must exercise greater caution in ensuring that the module 14 is matched to the proper container 12 in any tracking database. Additionally, the module 14 has the potential to come loose and fall off the container 12, such as by failure of the fastener. This may leave the notch 40 open and the contents of the container 12 exposed to the elements, and small contents of the container 12 may fall out.

The inventions have been described in the context of preferred and other embodiments and not every embodiment of the invention has been described. Obvious modifications and alterations to the described embodiments are available to those of ordinary skill in the art. For example, discussion of singular elements can also include plural elements and vice-versa. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A system for identifying contents of a container, the system comprising:
an interrogation trigger affixed to an outside surface of the container;
an interrogation transmitter affixed to an outside surface of the container;
a response receiver affixed to an outside surface of the container; and
a response transmitter affixed to an outside surface of the container.

2. The system as set forth in claim 1, wherein the interrogation trigger, the interrogation transmitter, the response receiver, and the response transmitter are all embedded within a module affixed to an outside surface of the container.

3. The system as set forth in claim 1, wherein the interrogation trigger is an interrogation receiver that receives an interrogation signal from an external RFID reader.

4. The system as set forth in claim 1, wherein the interrogation trigger is a switch.

5. The system as set forth in claim 1, wherein the interrogation trigger is a photovoltaic cell.

6. The system as set forth in claim 1, further including a reconfigurable memory operable to store information received by the response receiver for future transmission by the response transmitter.

7. The system as set forth in claim 1, further including a power source to power the interrogation transmitter.

8. The system as set forth in claim 1, wherein, upon activation of the interrogation trigger, the interrogation transmitter sends an interrogation signal into the container, the response receiver receives a response signal from items within the container, and thereafter the response transmitter is operable to forward information from the response signal.

9. A system for identifying contents of a container, the system comprising:
the container; and
a module embedded within a wall of the container, the module including;
an interrogation trigger;
an interrogation transmitter;
a response receiver; and
a response transmitter.

10. The system as set forth in claim 9, wherein the interrogation trigger, the interrogation transmitter, the response receiver, and the response transmitter are all embedded within the module.

11. The system as set forth in claim 9, wherein the interrogation trigger is an interrogation receiver that receives an interrogation signal from an external RFID reader.

12. The system as set forth in claim 9, wherein the interrogation trigger is a switch.

13. The system as set forth in claim 9, wherein the interrogation trigger is a photovoltaic cell.

14. The system as set forth in claim 9, wherein the module further includes a reconfigurable memory operable to store information received by the response receiver for future transmission by the response transmitter.

15. The system as set forth in claim 9, wherein the module further includes a power source to power the interrogation transmitter.

16. The system as set forth in claim 9, wherein, upon activation of the interrogation trigger, the interrogation transmitter sends an interrogation signal into the container, the response receiver receives a response signal from items within the container, and thereafter the response transmitter is operable to forward information from the response signal.

18. A system for identifying contents of a container, the system comprising:
a module affixed to the container, the module including;
an interrogation trigger;
an interrogation transmitter;
a response receiver;
a response transmitter;
a reconfigurable memory operable to store the information received by the response receiver for future transmission by the response transmitter; and
a power source to power at least the interrogation transmitter;
wherein the interrogation trigger, the interrogation transmitter, the response receiver, and the response transmitter are all embedded within the module; and
wherein, upon activation of the interrogation trigger, the interrogation transmitter sends an interrogation signal into the container, the response receiver receives a response signal from items within the container, and thereafter the response transmitter is operable to forward information from the response signal.

19. The system as set forth in claim 18, wherein the module is embedded within the a wall of the container.

20. The system as set forth in claim 18, wherein the module is affixed to an outside surface of the container.
